(19) United States
(12) Patent Application Publication
(10) Pub. No.: US 2016/0295272 A1
(43) Pub. Date: Oct. 6, 2016

(54) Method and Device for Playing Video File

(71) Applicant: Tencent Technology (Shenzhen) Company Limited, Shenzhen (CN)

(72) Inventor: Dalong LI, Shenzhen (CN)

(21) Appl. No.: 15/154,002

(22) Filed: May 13, 2016

Related U.S. Application Data
(63) Continuation of application No. PCT/CN2014/092195, filed on Nov. 25, 2014.

(30) Foreign Application Priority Data
Nov. 29, 2013 (CN) 201310627592.5

(51) Int. Cl. H04N 21/43; H04N 21/8547; H04N 21/8545; H04N 21/41; H04N 21/472

(52) U.S. Cl. CPC H04N 21/4307; H04N 21/4131; H04N 21/47217; H04N 21/8545; H04N 21/8547

(57) ABSTRACT

The disclosure discloses a method and device for playing a video file, and belongs to the field of Internet communication. The method includes that: a video file and interaction description file of a video to be played are acquired, the interaction description file including a corresponding relationship between an interactive operation command and play time; when the video file is played, the interaction description file is searched for whether there is an interactive operation command corresponding to current play time or not according to the current play time on a timeline of the video file; and if the corresponding interactive operation command is found, an interactive operation corresponding to the found interactive operation command is executed. The device includes: an acquisition module, a play searching module and an execution module. By the disclosure, a user may feel a real scenario in the video file.

### TECHNICAL FIELD

The disclosure relates to the field of Internet communication, and in particular to a method and device for playing a video file.

### BACKGROUND

Along with development of a video technology, numerous video files have emerged in the market, and users may play the video files to watch videos through terminals.

At present, when a video file is played, a terminal acquires the video file of a video to be played, wherein the video file includes a corresponding relationship between image data and play time, a corresponding relationship between sound data and the play time and a corresponding relationship between caption information and the play time; and the terminal acquires play time corresponding to a current play position on a timeline in real time, searches the video file of the video to be played for the corresponding image data, sound data and caption information according to the acquired play time, and plays the found image data, sound data and caption information.

In a process of implementing the disclosure, the inventor discovers that a conventional art at least has the following problem:

since a video file played in the conventional art only plays an image, a sound and a caption, it is difficult for a user to feel a real scenario in the video file; and for example, when an earthquake scenario is played, only an image, a sound and a caption are played, and it is difficult for the user to feel a real scenario of seismic shocks.

### SUMMARY

In order to make a user feel a real scenario in a video file, the disclosure provides a method and device for playing a video file. The technical solutions are as follows.

A method for playing a video file is provided, which may include that:

a video file and interaction description file of a video to be played are acquired, the interaction description file including a corresponding relationship between an interactive operation command and play time;

when the video file is played, the interaction description file is searched for whether there is an interactive operation command corresponding to current play time or not according to the current play time on a timeline of the video file; and

if the corresponding interactive operation command is found, interactive operation corresponding to the found interactive operation command is executed.

A device for playing a video file is provided, which may include:

an acquisition module, configured to acquire a video file and interaction description file of a video to be played, the interaction description file including a corresponding relationship between an interactive operation command and play time;

a play searching module, configured to, when the video file is played, search the interaction description file for whether there is an interactive operation command corresponding to current play time or not according to the current play time on a timeline of the video file; and

an execution module, configured to, if the corresponding interactive operation command is found, execute interactive operation corresponding to the found interactive operation command.

In the embodiment of the disclosure, the video file and interaction description file of the video to be played are acquired, the interaction description file including the corresponding relationship between the interactive operation command and the play time; the video file is played, play time corresponding to a current play position on the timeline of the video to be played is acquired, and the interaction description file is searched according to the acquired play time; and if the corresponding interactive operation command is found, the interactive operation corresponding to the found interactive operation command is executed. Since both the video file and interaction description file of the video to be played are acquired, and the interactive operation is executed at the corresponding play time according to the interaction description file, so that the user may feel the real scenario in the video file more.

### BRIEF DESCRIPTION OF THE DRAWINGS

FIG. 1 is a flowchart of a method for playing a video file according to embodiment 1 of the disclosure;

FIG. 2 is a flowchart of a method for playing a video file according to embodiment 2 of the disclosure;

FIG. 3 is a diagram of an interface for playing a video file according to embodiment 2 of the disclosure;

FIG. 4 is a flowchart of a method for playing a video file according to embodiment 3 of the disclosure; and

FIG. 5 is a structure diagram of a device for playing a video file according to embodiment 4 of the disclosure.

### DETAILED DESCRIPTION OF THE EMBODIMENTS

In order to make a purpose, technical solutions and advantages of the disclosure clearer, implementation modes of the disclosure will be further described below with reference to the drawings in detail.

### Embodiment 1

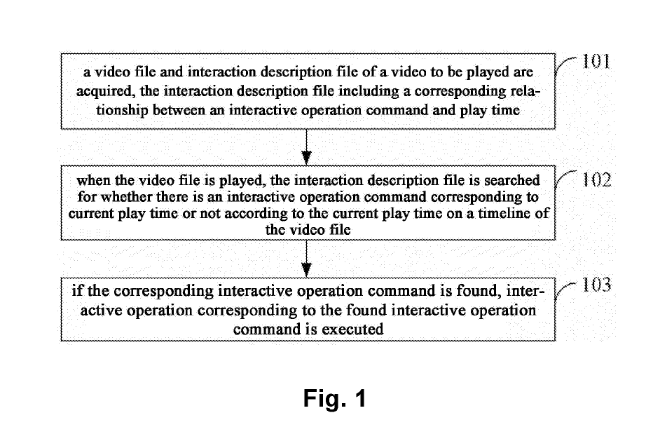

Referring to FIG. 1, the embodiment of the disclosure provides a method for playing a video file, which includes:

Step 101: a video file and interaction description file of a video to be played are acquired, the interaction description file includes a corresponding relationship between an interactive operation command and play time;

Step 102: when the video file is played, the interaction description file is searched for whether there is an interactive operation command corresponding to current play time or not according to the current play time on a timeline of the video file; and

Step 103: if the corresponding interactive operation command is found, interactive operation corresponding to the found interactive operation command is executed.

Preferably, the step that the interactive operation corresponding to the found interactive operation command is executed includes that:

Hardware equipment configured to execute the interactive operation is identified according to the found interactive operation command, and the hardware equipment is driven to execute the interactive operation corresponding to the interactive operation command.

Preferably, the step that the hardware equipment configured to execute the interactive operation is identified includes that:

A corresponding relationship between an interactive operation command and a system driving interface is searched for a corresponding system driving interface according to the found interactive operation command;

A hardware equipment identifier corresponding to the found system driving interface is acquired from a corresponding relationship between a system driving interface and a hardware equipment identifier to identify the hardware equipment corresponding to the hardware equipment identifier.

Then, the interactive operation command may be sent to the hardware equipment corresponding to the hardware equipment identifier to enable the hardware equipment to execute the interactive operation corresponding to the interactive operation command.

Preferably, the interactive operation includes at least one of vibration, flashing, shooting, sound amplification, production of an alarm sound, blowing, water spraying, smog production, bubbling, odor production, scene layout, figure performance, sending of information to a contact in a preset program in a mobile terminal, sending of information to a mobile terminal in a preset range and control over a home network terminal for execution of preset operation.

Preferably, the step that the video file and interaction description file of the video to be played are acquired includes that:

A play request message is sent to a video server, the play request message containing an identifier of the video to be played; a video data package of the video to be played is received from the video server, the video data package including the video file and the interaction description file; and

The video data package is decompressed to obtain the video file and the interaction description file.

In the embodiment of the disclosure, the video file and interaction description file of the video to be played are acquired, the interaction description file including the corresponding relationship between the interactive operation command and the play time; the video file is played, play time corresponding to a current play position on the timeline of the video to be played is acquired, and the interaction description file is searched according to the acquired play time; and if the corresponding interactive operation command is found, the interactive operation corresponding to the found interactive operation command is executed. Since both the video file and interaction description file of the video to be played are acquired, and the interactive operation is executed at the corresponding play time according to the interaction description file, so that a user may feel a real scenario in the video file more.

### Embodiment 2

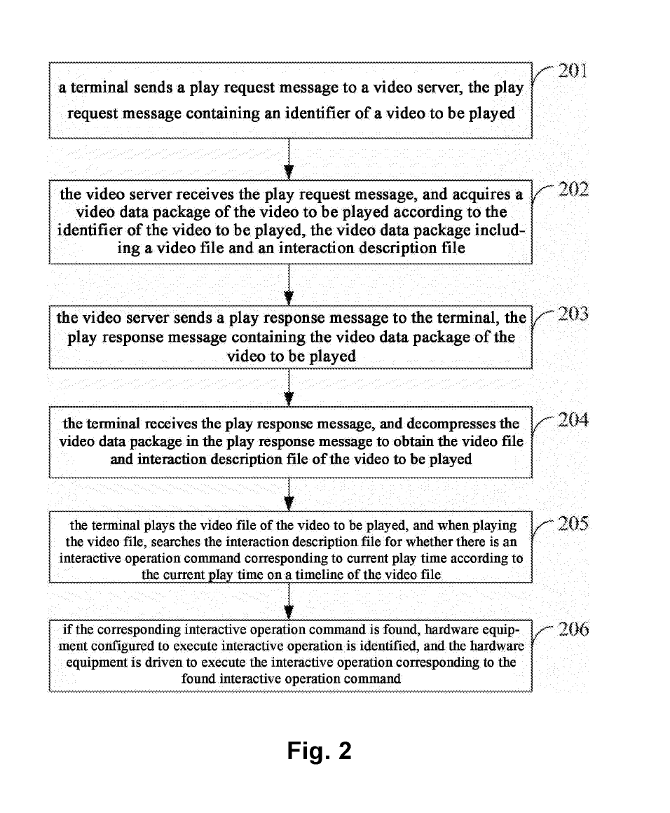

Referring to FIG. 2, the embodiment of the disclosure provides a method for playing a video file. A terminal acquires a video file and interaction description file of a video to be played from a video server, plays the video file of the video to be played and executes an interactive operation command included in the interaction description file of the video to be played. The method includes:

Step 201: the terminal sends a play request message to the video server, the play request message containing an identifier of the video to be played.

For example, the terminal sends the play request message to the video server, the play request message containing the identifier URL1 of the video Video1 to be played.

Step 202: the video server receives the play request message, and acquires a video data package of the video to be played according to the identifier of the video to be played, the video data package including the video file and the interaction description file.

Specifically, the video server receives the play request message, and acquires the video data package of the video to be played from a stored corresponding relationship between a video identifier and a video data package according to the identifier of the video to be played in the play request message, the video data package including the video file and the interaction description file.

Wherein, the video file includes a corresponding relationship between video data and play time, the video data including image data, sound data and/or caption information; and the interaction description file includes a corresponding relationship between an interactive operation command and the play time.

For example, the video server receives the play request message, and acquires the video data package F1 of the video Video1 to be played from the stored corresponding relationship, shown in Table 1, between the video identifier and the video data package according to the identifier URL1 of the video Video1 to be played in the play request message, the video data package F1 including the video file and the interaction description file.

TABLE 1

| Video identifier | Video data package |
|---|---|
| URL1 | FF1 |
| . . . | . . . |

Wherein, the video file includes the corresponding relationship, shown in Table 2, between the video data and the play time, and the video data includes the image data, the sound data and/or the caption information; and the interaction description file includes the corresponding relationship, shown in Table 3, between the interactive operation command and the play time.

TABLE 2

Video data

| Image | Sound | Caption | Play time |
|---|---|---|---|
| Picture1 | Sound1 | Word1 | 00:01:30 |
| Picture2 | Sound2 | Word2 | 00:01:45 |
| . . . | . . . | . . . | . . . |

TABLE 3

| Interactive operation command | Play time |
|---|---|
| S0 | 00:01:30 |
| S1 | 00:05:30 |
| . . . | . . . |

Wherein, a video provider edits the video file and interaction description file of the video in advance, compresses the video file and the interaction description file into the video data package, and stores the video data package of the video in the video server.

Step 203: the video server sends a play response message to the terminal, the play response message containing the video data package of the video to be played.

For example, the video server sends the play response message to the terminal, the play response message containing the video data package F1 of the video Video1 to be played.

Step 204: the terminal receives the play response message, and decompresses the video data package in the play response message to obtain the video file and interaction description file of the video to be played.

For example, the terminal receives the play response message, and decompresses the video data package F1 in the play response message to acquire the video file and interaction description file of the video Video1 to be played.

Step 205: the terminal plays the video file of the video to be played, and when playing the video file, searches the interaction description file for whether there is an interactive operation command corresponding to current play time according to the current play time on a timeline of the video file.

Specifically, the terminal plays the video data corresponding to the play time in the video file according to the video file, detects the timeline of the video to be played in real time, acquires play time corresponding to a current play position on the timeline, and searches a corresponding relationship between an interactive operation command and the play time in the interaction description file according to the acquired play time.

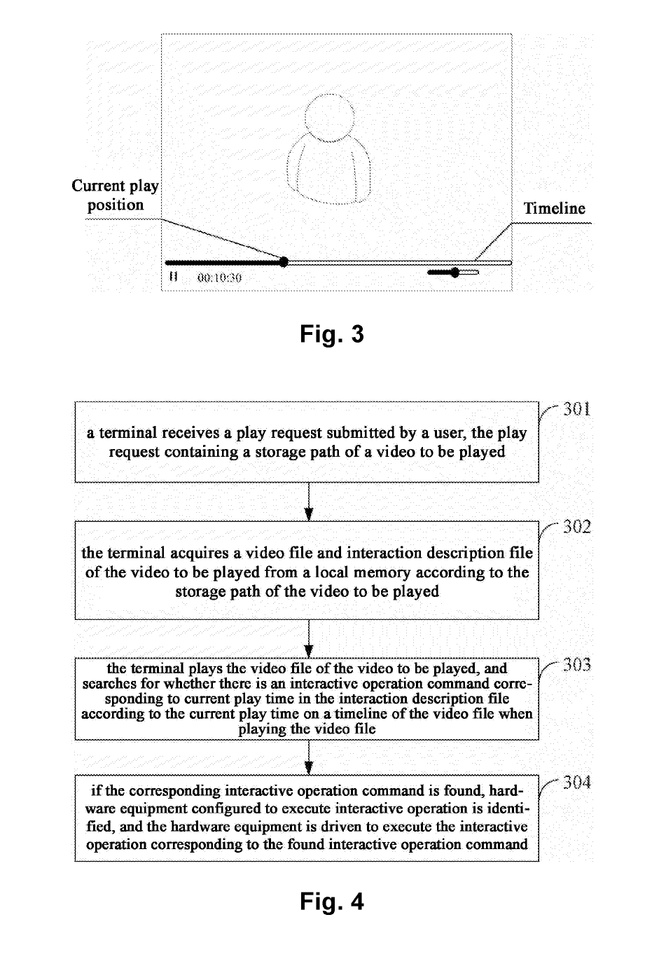

For example, the terminal plays image Picture1, sound Sound1 and caption information Word1 in video data corresponding to play time 00:01:30 in the video file according to the video file, detects the timeline of the video Video1 to be played in real time, acquires play time 00:10:30 corresponding to a current play position on the timeline, and as shown in FIG. 3, searches the corresponding relationship, shown in Table 3, between the interactive operation command and the play time in the interaction description file according to the acquired play time 00:10:30.

Step 206: if the corresponding interactive operation command is found, hardware equipment configured to execute interactive operation is identified, and the hardware equipment is driven to execute the interactive operation corresponding to the found interactive operation command.

Specifically, if the corresponding interactive operation command is found, a corresponding relationship between an interactive operation command and a system driving interface is searched for a corresponding system driving interface according to the found interactive operation command; a hardware equipment identifier corresponding to the found system driving interface is acquired from a corresponding relationship between a system driving interface and a hardware equipment identifier; and the found interactive operation command is sent to the hardware equipment corresponding to the hardware equipment identifier to enable the hardware equipment to execute the interactive operation corresponding to the interactive operation command. The corresponding relationship between the interactive operation command and the system driving interface and the corresponding relationship between the system driving interface and the hardware equipment identifier may be stored in the terminal or stored in equipment accessible for the terminal in advance.

Wherein, the interactive operation may be vibration, flashing, shooting, sound amplification, production of an alarm sound, blowing, water spraying, smog production, bubbling, odor production, scene layout, figure performance, sending of information to a contact in a preset program in a mobile terminal, sending of information to a mobile terminal in a preset range and control over a home network terminal for execution of preset operation, and will not be illustrated one by one.

Wherein, when the information is sent to the contact in the preset program in the mobile terminal, the preset program may be instant messaging software and the like, and will not be illustrated one by one.

Wherein, the home network terminal may be an intelligent television, an intelligent microwave oven, an intelligent air conditioner, intelligent doorbell equipment and the like, and will not be illustrated one by one.

Wherein, the hardware equipment may be a vibrator, a flashlight, a camera, a Bluetooth speaker, intelligent clock equipment, a direct/gravity/acceleration sensor, a gyroscope, a Near Field Communication (NFC) module, a fingerprint identification sensor, an intelligent lamp, an intelligent mobile phone, an intelligent television, an intelligent microwave oven, an intelligent air conditioner, intelligent doorbell equipment and the like, and will not be illustrated one by one.

Wherein, the hardware equipment may execute the corresponding interactive operation according to the interactive operation command, and for example, the vibrator executes the vibration operation according to a vibration operation command, the flashlight executes the flashing operation according to a flashing operation command, the camera executes the shooting operation according to a shooting operation command, the speaker executes the sound amplification operation according to a sound amplification operation command, the intelligent clock equipment executes the alarm sound production operation according to an alarm sound production operation command, the intelligent lamp executes dark light emission operation according to a dark light emission operation command, the intelligent mobile phone executes the operation of sending the information to the contact in the preset program according to an operation command of sending the information to the contact in the preset program, the intelligent mobile phone executes the operation of sending the information to the intelligent terminal in the preset range according to an operation command of sending the information to the intelligent terminal in the preset range, the intelligent television executes bright light emission operation according to a bright light emission operation command, the intelligent microwave oven executes the sound production operation according to a sound production operation command, the intelligent air conditioner executes cooling operation according to a cooling operation command, the intelligent doorbell equipment executes doorbell production operation according to a doorbell production operation command, and the like.

Wherein, as shown in Table 4, each kind of interactive operation is applicable to a certain video scenario, the vibration operation is applicable to a video scenario of a gunfight, an explosion, an earthquake and the like, the flashing operation is applicable to a video scenario of shooting at night, thrilling and the like, the shooting operation with a camera is applicable to a video scenario of a comedy, a video scenario probably causing violent mood swing of audience and the like, physical positioning operation is applicable to a video scenario of person tracking, escaping and the like, a breathing lamp is applicable to a video scenario of atmosphere conditioning and the like, making a voice call to a current mobile phone is applicable to an indoor thrilling scenario, making a voice call to another mobile phone is applicable to an emergency and a thrilling scenario, operating a remote speaker is applicable to atmosphere conditioning, instant enhancement of an audio effect and the like, operating an intelligent television is applicable to instant enhancement of an audio effect and the like, and operating intelligent clock equipment is applicable to a manmade emergency, a thrilling scenario and the like.

TABLE 4

| Interactive operation | Applicable video scenario |
|---|---|
| Vibration | Video scenario of gunfight, |
| | explosion, earthquake and the like |
| Flashlight | Video scenario of shooting at night |
| | and thrilling |
| Camera | Scenario of comedy and scenario |
| | probably causing violent mood swing |
| | of audience |
| Physical positioning | Video scenario of person tracking, |
| | escaping and the like |
| Breathing lamp | Atmosphere conditioning |
| Making a voice call to a current | Indoor thrilling scenario |
| mobile phone | |
| Making a voice call to another | Manmade emergency and thrilling |
| mobile phone | scenario |
| Operating a remote (for example, | Instant enhancement of an audio |
| Bluetooth-connected) speaker | effect |
| Operating an intelligent | Instant enhancement of an audio |
| television | effect |
| Operating intelligent clock | Manmade emergency and thrilling |
| equipment | scenario |
| . . . | . . . |

Furthermore, if no corresponding interactive operation command is found, it is determined that there is no corresponding interactive operation command corresponding to the play time corresponding to the current play position.

For example, the corresponding relationship, shown in Table 3, between the interactive operation command and the play time in the interaction description file is searched according to the acquired play time 00:10:30 and the corresponding interactive operation command S0 are found, the corresponding system driving interface I0 is found from the corresponding relationship, shown in Table 5, between the interactive operation command and the system driving interface according to the found interactive operation command S0; the hardware equipment identifier H0 corresponding to the system driving interface I0 is acquired from the corresponding relationship, shown in Table 6, between the system driving interface and the hardware equipment identifier; and the found interactive operation command S0 is sent to the hardware equipment corresponding to the hardware equipment identifier H0 to enable the hardware equipment to execute the interactive operation corresponding to the interactive operation command S0. For example, if the interactive operation command S0 is a vibration operation command, the corresponding interactive operation is vibration, the corresponding hardware equipment is a vibrator, and the vibration operation command is sent to the vibrator to enable the vibrator to execute vibration operation according to the vibration operation command.

TABLE 5

| Interactive operation command | System driving interface |
|---|---|
| S0 | I0 |
| . . . | . . . |

TABLE 6

| System driving interface | Hardware equipment identifier |
|---|---|
| I0 | H0 |
| . . . | . . . |

Furthermore, if the terminal plays image Picture2, sound Sound2 and caption information Word2 included in video data corresponding to play time 00:01:45 in the video file according to the video file, the play time 00:01:45 corresponding to the current play position on the timeline of the video Video1 to be played is acquired, the corresponding relationship, shown in Table 3, between the interactive operation command and the play time in the interaction description file is searched according to the acquired play time 00:01:45, and if no corresponding interactive operation command is found, it is determined that there is no interactive operation command corresponding to the play time corresponding to the current play position.

Furthermore, the terminal still stores the video file and interaction description file of the video to be played after acquiring the video file and interaction description file of the video to be played from the video server, and may directly acquire the video file and interaction description file of the video to be played from a local memory when playing the video again.

Wherein, in the embodiment of the disclosure, the interaction description file may also be configured to store a corresponding relationship among an interactive operation command, interactive operation configuration information and play time, and the interactive operation configuration information may be a duration of the interactive operation, intensity of the interactive operation, an interval of the interactive operation and/or the like, and will not be illustrated one by one.

Correspondingly, in Step 206, if the corresponding interactive operation command is found, the hardware equipment configured to execute the interactive operation is identified according to interactive operation configuration information corresponding to the found interactive operation command, and the hardware equipment is driven to execute the interactive operation corresponding to the found interactive operation command.

The step that the hardware equipment configured to execute the interactive operation is identified and the interactive operation corresponding to the found interactive operation command is executed may specifically be implemented as follows:

The corresponding relationship, stored in the interaction description file, among the interactive operation command, the interactive operation configuration information and the play time is searched according to the acquired play time corresponding to the current play position, and if the corresponding interactive operation command and interactive operation configuration information are found, the corresponding relationship between the interactive operation command and the system driving interface is searched for the corresponding system driving interface according to the found interactive operation command; the hardware equipment identifier corresponding to the found system driving interface is acquired from the corresponding relationship between the system driving interface and the hardware equipment identifier; and the found interactive operation command and interactive operation configuration information are sent to the hardware equipment corresponding to the hardware equipment identifier to enable the hardware equipment to execute the interactive operation corresponding to the interactive operation command according to the interactive operation command and the interactive operation configuration information.

Wherein, in the embodiment of the disclosure, an organization manner for the interaction description file may be an Extensible Markup Language (XML)-based interaction description file and the like. For example, a structure of the XML-based interaction description file is shown as follows:

<?xml version=”1.0” encoding=”UTF-8”?>
<movie name=”ABC” duration=”01:45:23” platform=”android”>
<atom position=”00:01:30”>
<action type=”shake” duration=”10” strength=”high”/>
<action type=”flash” duration=”15” strength=”middle” interval=”2”/>
</atom>
<atom position=”00:05:30”>
<action type=”camera” duration=”10” mode=”front-facing”/>
</atom>
<atom position=”01:09:45”>
<action type=”GPS” duration=”20” mode=”tracing”/>
</atom>
</movie>

Wherein, a video information global description node movie label field in the abovementioned code is configured to describe global information of the video to be played to describe a characteristic of the video, the global information at least includes a video name, a video duration and a hardware/software operating system platform recommended to implement the interactive operation, and for example, the abovementioned code indicates that the video name of the video to be played is ABC, the duration is 01:45:23 and the hardware/software operating system platform recommended for implementation is android; under the movie label field, there is one or more interactive definition and description node atom label fields, the atom label fields are configured to indicate corresponding relationships between specific play time and interactive operation commands, information of the atom label fields at least includes play time position, it is important to note that all the atom label fields are required to be arranged in a monotonic increasing sequence of the play time, and for example, in the abovementioned code, the play time position of the three atom label fields is 00:01:30, 00:05:30 and 01:09:45 respectively, and is arranged in the monotonic increasing sequence of the play time; each atom label field includes one or more interactive operation command node action label fields, the action label fields are configured to describe the interactive operation commands corresponding to the specific play time, information of the action label fields at least includes an interactive operation type, the duration of the interactive operation and strength of the interactive operation, it is important to note that an arrangement sequence of the multiple action label fields is determined according to the video file, and for example, the first action label field in the abovementioned code indicates that vibration is produced at play time 00:01:30, a duration of vibration is 10 seconds, strength of vibration is high, flashing is generated after vibration, a duration of flashing is 15 seconds, flashing strength is middle and a flashing interval is 2 seconds.

Wherein, the hardware equipment disclosed in the disclosure may not be limited to one piece of equipment, and may be extended among multiple pieces of equipment or in a home intelligent equipment network. For example, the interaction description file stores a corresponding relationship among an interactive operation command configured to send information to an intelligent mobile phone in a preset range, interactive operation configuration information of which an information content is “it's rainy tomorrow” and play time when the mobile phone receives the information in the video in advance. When the video is watched through the intelligent terminal and the mobile phone in the video receives information in the video file, the intelligent terminal acquires a corresponding interactive operation command of “sending information to an intelligent mobile phone within a circle with a radius of 20 meters” from the corresponding relationship among the interactive operation command, the interactive operation configuration information and the play time in the interaction description file according to current play time, then acquires a corresponding hardware equipment identifier “Bluetooth” from the stored corresponding relationship between the interactive operation command and the hardware equipment identifier according to the acquired interactive operation command, drives the Bluetooth equipment to search for the intelligent mobile phone with the circle with the radius of 20 meters according to the hardware equipment identifier “Bluetooth”, and sends the information of which the information content is “it's rainy tomorrow” to the found intelligent mobile phone; and the interaction description file stores a corresponding relationship among an interactive operation command of emitting dark light, interactive operation configuration information which indicates a duration of 5 seconds and play time when light is suddenly darkened in the video and a corresponding relationship among an interactive operation command of producing a scream, interactive operation configuration information which indicates a duration of 5 seconds and play time when the scream is produced in the video in advance. When the video is watched through the intelligent terminal and a video scenario is that the light is suddenly darkened and the scream is produced, the intelligent terminal acquires corresponding interactive operation commands of “emitting dark light” and “producing a scream” and corresponding interactive operation configuration information which indicates that “the duration is 5 seconds” from the corresponding relationship among the interactive operation command, the interactive operation configuration information and the play time in the interaction description file according to the current play time, then acquires corresponding hardware equipment identifiers “intelligent lamp” and “Bluetooth speaker” from the stored corresponding relationship between the interactive operation command and the hardware equipment identifier according to the acquired interactive operation commands, drives the intelligent lamp to continuously emit dark light for 5 seconds according to the acquired hardware equipment identifier “intelligent lamp” and drives the Bluetooth speaker to continuously produce a scream for 5 seconds according to the hardware equipment identifier “Bluetooth speaker”.

In the embodiment of the disclosure, the terminal acquires the video file and interaction description file of the video to be played from the video server, the interaction description file including the corresponding relationship between the interactive operation command and the play time; the terminal plays the video file, acquires play time corresponding to a current play position on the timeline of the video to be played, and searches for the interaction description file according to the acquired play time; and if the corresponding interactive operation command is found, the hardware equipment is driven to execute the interactive operation corresponding to the found interactive operation command. Since both the video file and interaction description file of the video to be played are acquired, the corresponding hardware equipment is driven to execute the interactive operation at the corresponding play time according to the interaction description file, and the interactive operation may be executed by virtue of the intelligent terminal without changing the binary characteristic of the video file, so that the user may feel the real scenario in the video file more.

### Embodiment 3

Referring to FIG. 4, the embodiment of the disclosure provides a method for playing a video file. When playing a video to be played which has been played again, a terminal acquires a video file and interaction description file of the video to be played from a local memory, plays a video file of the video to be played and executes an interactive operation command in the interaction description file of the video to be played. The method includes:

Step 301: the terminal receives a play request submitted by a user, the play request containing a storage path of the video to be played.

For example, the terminal receives the play request submitted by the user, the play request containing a storage path Route1 of the video Video1 to be played.

Step 302: the terminal acquires the video file and interaction description file of the video to be played from the local memory according to the storage path of the video to be played.

Wherein, the video file includes a corresponding relationship between video data and play time, and the video data includes image data, sound data and/or caption information; and the interaction description file includes a corresponding relationship between an interactive operation command and the play time.

For example, the terminal acquires the video file and interaction description file of the video Video1 to be played from the local memory according to the storage path Route1 of the video Video1 to be played, wherein the video file includes the corresponding relationship, shown in Table 2, between the video data and the play time, and the video data includes the image data, the sound data and the caption information; and the interaction description file includes the corresponding relationship, shown in Table 3, between the interactive operation command and the play time.

Step 303: the terminal plays the video file of the video to be played, and searches for whether there is an interactive operation command corresponding to current play time in the interaction description file according to the current play time on a timeline of the video file when playing the video file.

Specifically, the terminal plays the video data corresponding to the play time in the video file according to the video file, detects the timeline of the video to be played in real time, acquires play time corresponding to a current play position on the timeline of the video to be played, and searches for the corresponding relationship between an interactive operation command and the play time in the interaction description file according to the acquired play time.

For example, the terminal plays image Picture1, sound Sound1 and caption information Word1 in video data corresponding to play time 00:01:30 in the video file according to the video file, detects the timeline of the video Video1 to be played in real time, acquires play time 00:10:30 corresponding to a current play position on the timeline, and as shown in FIG. 3, searches for the corresponding relationship, shown in Table 3, between the interactive operation command and the play time in the interaction description file according to the acquired play time 00:10:30.

Step 304: if the corresponding interactive operation command is found, hardware equipment configured to execute interactive operation is identified, and the hardware equipment is driven to execute the interactive operation corresponding to the found interactive operation command.

Specifically, if the corresponding interactive operation command is found, a corresponding relationship between an interactive operation command and a system driving interface is searched for a corresponding system driving interface according to the found interactive operation command; a hardware equipment identifier corresponding to the found system driving interface is acquired from a corresponding relationship between a system driving interface and a hardware equipment identifier; and the found interactive operation command is sent to the hardware equipment corresponding to the hardware equipment identifier to enable the hardware equipment to execute the interactive operation corresponding to the interactive operation command.

Wherein, the interactive operation may be vibration, flashing, shooting, sound amplification, production of an alarm sound, blowing, water spraying, smog production, bubbling, odor production, scene layout, figure performance, sending of information to a contact in a preset program in a mobile terminal, sending of information to a mobile terminal in a preset range, control over a home network terminal for execution of preset operation and the like, and will not be illustrated one by one.

Wherein, when the information is sent to the contact in the preset program in the mobile terminal, the preset program may be instant messaging software and the like, and will not be illustrated one by one.

Wherein, the home network terminal may be an intelligent television, an intelligent microwave oven, an intelligent air conditioner, intelligent doorbell equipment and the like, and will not be illustrated one by one.

Wherein, the hardware equipment may be a vibrator, a flashlight, a camera, a Bluetooth speaker, intelligent clock equipment, a direct/gravity/acceleration sensor, a gyroscope, an NFC module, a fingerprint identification sensor, an intelligent lamp, an intelligent mobile phone, an intelligent television, an intelligent microwave oven, an intelligent air conditioner, intelligent doorbell equipment and the like, and will not be illustrated one by one.

Wherein, the hardware equipment may execute the corresponding interactive operation according to the interactive operation command, and for example, the vibrator executes the vibration operation according to a vibration operation command, the flashlight executes the flashing operation according to a flashing operation command, the camera executes the shooting operation according to a shooting operation command, the speaker executes the sound amplification operation according to a sound amplification operation command, the intelligent clock equipment executes the alarm sound production operation according to an alarm sound production operation command, the intelligent lamp executes dark light emission operation according to a dark light emission operation command, the intelligent mobile phone executes the operation of sending the information to the contact in the preset program according to an operation command of sending the information to the contact in the preset program, the intelligent mobile phone executes the operation of sending the information to the intelligent terminal in the preset range according to an operation command of sending the information to the intelligent terminal in the preset range, the intelligent television executes bright light emission operation according to a bright light emission operation command, the intelligent microwave oven executes the sound production operation according to a sound production operation command, the intelligent air conditioner executes cooling operation according to a cooling operation command, the intelligent doorbell equipment executes doorbell production operation according to a doorbell production operation command, and the like.

Furthermore, if no corresponding interactive operation command is found, it is determined that there is no corresponding interactive operation command corresponding to the play time corresponding to the current play position.

For example, the corresponding relationship, shown in Table 3, between the interactive operation command and the play time in the interaction description file is searched according to the acquired play time 00:10:30 and the corresponding interactive operation command S0 are found, the corresponding system driving interface I0 is found from the corresponding relationship, shown in Table 5, between the interactive operation command and the system driving interface according to the found interactive operation command S0; the hardware equipment identifier H0 corresponding to the system driving interface I0 is acquired from the corresponding relationship, shown in Table 6, between the system driving interface and the hardware equipment identifier; and the found interactive operation command S0 is sent to the hardware equipment corresponding to the hardware equipment identifier H0 to enable the hardware equipment to execute the interactive operation corresponding to the interactive operation command S0. For example, if the interactive operation command S0 is a vibration operation command, the corresponding interactive operation is vibration, the corresponding hardware equipment is a vibrator, and the vibration operation command is sent to the vibrator to enable the vibrator to execute vibration operation according to the vibration operation command.

Furthermore, if the terminal plays image Picture2, sound Sound2 and caption information Word2 included in video data corresponding to play time 00:01:45 in the video file according to the video file, the play time 00:01:45 corresponding to the current play position on the timeline of the video Video1 to be played is acquired, the corresponding relationship, shown in Table 3, between the interactive operation command and the play time in the interaction description file is searched according to the acquired play time 00:01:45, and if no corresponding interactive operation command is found, it is determined that there is no interactive operation command corresponding to the play time corresponding to the current play position.

Wherein, the hardware equipment disclosed in the disclosure may not be limited to one piece of equipment, and may be extended among multiple pieces of equipment or in a home intelligent equipment network. For example, the interaction description file stores a corresponding relationship among an interactive operation command configured to send information to an intelligent mobile phone in a preset range, interactive operation configuration information of which an information content is “it's rainy tomorrow” and play time when the mobile phone receives the information in the video in advance. When the video is watched through the intelligent terminal and the mobile phone in the video receives information in the video file, the intelligent terminal acquires a corresponding interactive operation command of “sending information to an intelligent mobile phone within a circle with a radius of 20 meters” from the corresponding relationship among the interactive operation command, the interactive operation configuration information and the play time in the interaction description file according to current play time, then acquires a corresponding hardware equipment identifier “Bluetooth” from the stored corresponding relationship between the interactive operation command and the hardware equipment identifier according to the acquired interactive operation command, drives the Bluetooth equipment to search for the intelligent mobile phone with the circle with the radius of 20 meters according to the hardware equipment identifier “Bluetooth”, and sends the information of which the information content is “it's rainy tomorrow” to the found intelligent mobile phone; and the interaction description file stores a corresponding relationship among an interactive operation command of emitting dark light, interactive operation configuration information which indicates a duration of 5 seconds and play time when light is suddenly darkened in the video and a corresponding relationship among an interactive operation command of producing a scream, interactive operation configuration information which indicates a duration of 5 seconds and play time when the scream is produced in the video in advance. When the video is watched through the intelligent terminal and a video scenario is that the light is suddenly darkened and the scream is produced, the intelligent terminal acquires corresponding interactive operation commands of “emitting dark light” and “producing a scream” and corresponding interactive operation configuration information which indicates that “the duration is 5 seconds” from the corresponding relationship among the interactive operation command, the interactive operation configuration information and the play time in the interaction description file according to the current play time, then acquires corresponding hardware equipment identifiers “intelligent lamp” and “Bluetooth speaker” from the stored corresponding relationship between the interactive operation command and the hardware equipment identifier according to the acquired interactive operation commands, drives the intelligent lamp to continuously emit dark light for 5 seconds according to the acquired hardware equipment identifier “intelligent lamp” and drives the Bluetooth speaker to continuously produce a scream for 5 seconds according to the hardware equipment identifier “Bluetooth speaker”. In the embodiment of the disclosure, the terminal acquires the video file and interaction description file of the video to be played from the local memory, the interaction description file including the corresponding relationship between the interactive operation command and the play time; the terminal plays the video file, acquires play time corresponding to a current play position on the timeline of the video to be played, and searches for the interaction description file according to the acquired play time; and if the corresponding interactive operation command is found, the hardware equipment is driven to execute the interactive operation corresponding to the found interactive operation command. Since both the video file and interaction description file of the video to be played are acquired, the corresponding hardware equipment is driven to execute the corresponding interactive operation at the corresponding play time according to the interaction description file, and the interactive operation may be executed by virtue of the intelligent terminal without changing a binary characteristic of the video file, so that the user may feel the real scenario in the video file more.

### Embodiment 4

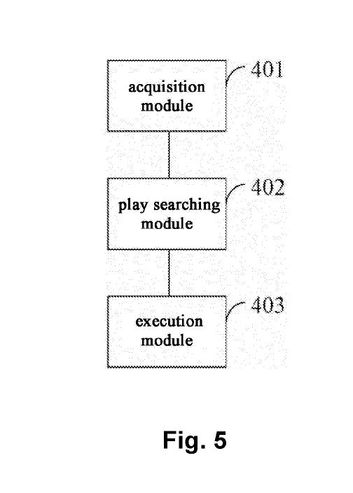

Referring to FIG. 5, the embodiment of the disclosure provides a device for playing a video file, which includes:

An acquisition module 401, configured to acquire a video file and interaction description file of a video to be played, the interaction description file including a corresponding relationship between an interactive operation command and play time;

A play searching module 402, configured to, when the video file is played, search the interaction description file for whether there is an interactive operation command corresponding to current play time or not according to the current play time on a timeline of the video file;

An execution module 403, configured to, if the corresponding interactive operation command is found, execute interactive operation corresponding to the found interactive operation command.

If a terminal plays the video file of the video to be played for the first time, the acquisition module 401 acquires a video data package of the video to be played from a video server, and decompresses the video data package of the video to be played to obtain the video file and interaction description file of the video to be played, and if the terminal plays the video file of the video to be played again, the acquisition module 401 acquires the video file and interaction description file of the video to be played from a local memory.

The play searching module 402 plays video data corresponding to play time in the video file according to the video file, detects a timeline of the video to be played in real time, acquires play time corresponding to a current play position on the timeline, and searches for the corresponding relationship between the interactive operation command and the play time in the interaction description file according to the acquired play time.

If the corresponding interactive operation command is found, the execution module 403 searches a corresponding relationship between an interactive operation command and a system driving interface for a corresponding system driving interface according to the found interactive operation command, acquires a hardware equipment identifier corresponding to the found system driving interface from a corresponding relationship between a system driving interface and a hardware equipment identifier, and sends the found interactive operation command to hardware equipment corresponding to the hardware equipment identifier to enable the hardware equipment to execute the interactive operation corresponding to the interactive operation command.

Wherein, the execution module 403 includes:

An identification unit, configured to identify the hardware equipment configured to execute the interactive operation according to the found interactive operation command;

A driving unit, configured to drive the identified hardware equipment to execute the interactive operation corresponding to the interactive operation command.

Wherein, the identification unit includes:

A searching subunit, configured to search the corresponding relationship between the interactive operation command and the system driving interface for the corresponding system driving interface according to the found interactive operation command;

An acquisition subunit, configured to acquire the hardware equipment identifier corresponding to the found system driving interface from the corresponding relationship between the system driving interface and the hardware equipment identifier to identify the hardware equipment corresponding to the hardware equipment identifier.

The execution module may further include a sending unit, configured to send the interactive operation command to the hardware equipment corresponding to the hardware equipment identifier to enable the hardware equipment to execute the interactive operation corresponding to the interactive operation command.

Wherein, the interactive operation at least includes one of vibration, flashing, shooting, sound amplification, production of an alarm sound, blowing, water spraying, smog production, bubbling, odor production, scene layout, figure performance, sending of information to a contact in a preset program in a mobile terminal, sending of information to a mobile terminal in a preset range and control over a home network terminal for execution of preset operation.

Wherein, the acquisition module 401 includes:

A sending unit, configured to send a play request message to the video server, the play request message containing an identifier of the video to be played;

A receiving unit, configured to receive a video data package of the video to be played from the video server, the video data package including the video file and the interaction description file; and

A decompression unit, configured to decompress the video data package to obtain the video file and the interaction description file.

In the embodiment of the disclosure, the video file and interaction description file of the video to be played are acquired, the interaction description file including the corresponding relationship between the interactive operation command and the play time; the video file is played, play time corresponding to a current play position on the timeline of the video to be played is acquired, and the interaction description file is searched according to the acquired play time; and if the corresponding interactive operation command is found, the interactive operation corresponding to the found interactive operation command is executed. Since both the video file and interaction description file of the video to be played are acquired, and the interactive operation is executed at the corresponding play time according to the interaction description file, so that a user may feel a real scenario in the video file more.

Those skilled in the art should know that all or part of the steps implementing the embodiment may be implemented by hardware and may also be implemented by instructing related hardware through a program, the program may be stored in a computer-readable storage medium, and the abovementioned storage medium may be a read-only memory, a magnetic disk, a compact disc or the like.

The above is only the preferred embodiment of the disclosure and not intended to limit the invention. Any modifications, equivalent replacements, improvements and the like made within the spirit and principle of the disclosure shall fall within the scope of protection of the invention.

1. A method for playing a video file, comprising:
acquiring a video file and interaction description file of a video to be played, the interaction description file comprising a corresponding relationship between an interactive operation command and play time;
when the video file is played, searching the interaction description file for whether there is an interactive operation command corresponding to current play time or not according to the current play time on a timeline of the video file; and
if the corresponding interactive operation command is found, executing an interactive operation corresponding to the found interactive operation command.

2. The method according to claim 1, wherein executing the interactive operation corresponding to the found interactive operation command comprises:
identifying a hardware equipment, which is configured to execute the interactive operation, according to the found interactive operation command; and
driving the hardware equipment to execute the interactive operation corresponding to the interactive operation command.

3. The method according to claim 2, wherein identifying the hardware equipment, which is configured to execute the interactive operation, comprises:
searching a corresponding relationship between an interactive operation command and a system driving interface for a corresponding system driving interface according to the found interactive operation command; and
acquiring a hardware equipment identifier corresponding to the found system driving interface from a corresponding relationship between a system driving interface and a hardware equipment identifier to identify the hardware equipment corresponding to the hardware equipment identifier.

4. The method according to claim 1, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

5. The method according to claim 1, wherein acquiring the video file and interaction description file of the video to be played comprises:
sending a play request message to a video server, the play request message containing an identifier of the video to be played;
receiving a video data package of the video to be played sent from the video server, the video data package comprising the video file and the interaction description file; and
decompressing the video data package to obtain the video file and the interaction description file.

6. A device for playing a video file, comprising:
an acquisition module, configured to acquire a video file and interaction description file of a video to be played, the interaction description file comprising a corresponding relationship between an interactive operation command and play time;
a play searching module, configured to, when the video file is played, search the interaction description file for whether there is an interactive operation command corresponding to current play time or not according to the current play time on a timeline of the video file; and
an execution module, configured to, if the corresponding interactive operation command is found, execute an interactive operation corresponding to the found interactive operation command.

7. The device according to claim 6, wherein the execution module comprises:
an identification unit, configured to identify a hardware equipment, which is configured to execute the interactive operation, according to the found interactive operation command; and
a driving unit, configured to drive the hardware equipment to execute the interactive operation corresponding to the interactive operation command.

8. The device according to claim 7, wherein the identification unit comprises:
a searching subunit, configured to search a corresponding relationship between an interactive operation command and a system driving interface for a corresponding system driving interface according to the found interactive operation command; and
an acquisition subunit, configured to acquire a hardware equipment identifier corresponding to the found system driving interface from a corresponding relationship between a system driving interface and a hardware equipment identifier to identify the hardware equipment corresponding to the hardware equipment identifier.

9. The device according to claim 6, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

10. The device according to claim 6, wherein the acquisition module comprises:
a sending unit, configured to send a play request message to a video server, the play request message containing an identifier of the video to be played;
a receiving unit, configured to receive a video data package of the video to be played sent from the video server, the video data package comprising the video file and the interaction description file; and
a decompression unit, configured to decompress the video data package to obtain the video file and the interaction description file.

11. An equipment for playing a video file, comprising:
a device, configured to acquire a video file and interaction description file of a video to be played, the interaction description file comprising a corresponding relationship between an interactive operation command and play time;
a device, configured to, when the video file is played, search the interaction description file for whether there is an interactive operation command corresponding to current play time or not according to the current play time on a timeline of the video file; and
a device, configured to execute an interactive operation corresponding to the found interactive operation command under the condition that corresponding interactive operation command is found.

12. The equipment according to claim 11, wherein the device configured to execute the interactive operation corresponding to the found interactive operation command under the condition that the found interactive operation command is found comprises:
a device, configured to identify a hardware equipment, which is configured to execute the interactive operation, according to the found interactive operation command; and
a device, configured to drive the hardware equipment to execute the interactive operation corresponding to the interactive operation command.

13. The equipment according to claim 12, wherein the device configured to identify the hardware equipment, which is configured to execute the interactive operation, according to the found interactive operation command comprises:
a device, configured to search a corresponding relationship between an interactive operation command and a system driving interface for a corresponding system driving interface according to the found interactive operation command; and
a device, configured to acquire a hardware equipment identifier corresponding to the found system driving interface from a corresponding relationship between a system driving interface and a hardware equipment identifier to identify the hardware equipment corresponding to the hardware equipment identifier.

14. The equipment according to claim 11, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

15. The equipment according to claim 11, wherein the device configured to acquire the video file and interaction description file of the video to be played comprises:
a device, configured to send a play request message to a video server, the play request message containing an identifier of the video to be played;
a device, configured to receive a video data package of the video to be played sent from the video server, the video data package comprising the video file and the interaction description file; and
a device, configured to decompress the video data package to obtain the video file and the interaction description file.

16. The method according to claim 2, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

17. The method according to claim 3, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

18. The device according to claim 7, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

19. The device according to claim 8, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.

20. The equipment according to claim 12, wherein the interactive operation at least comprises one of vibration, flashing, shooting, sound amplification, production of an alarm sound, blowing, water spraying, smog production, bubbling, odor production, scene layout, figure performance, sending information to a contact person in a preset program in a mobile terminal, sending information to a mobile terminal in a preset range and controlling a home network terminal to execute a preset operation.
